(19) United States
(12) Patent Application Publication
(10) Pub. No.: US 2024/0416992 A1
(43) Pub. Date: Dec. 19, 2024

(54) HYDRAULIC PUMP ASSEMBLY

(71) Applicant: Liebherr-Werk Bischofshofen GmbH, Bischofshofen (AT)

(72) Inventors: Florian ALTENBERGER, Gries (AT); Marco EDER, Zell am See (AT); Johannes HOFBAUER, Eugendorf (AT); Josef STOCK, Bischofshofen (AT); Reinhard WINDHOFER, Mühlbach/Hkg. (AT)

(21) Appl. No.: 18/742,950

(22) Filed: Jun. 13, 2024

(30) Foreign Application Priority Data
Jun. 13, 2023 (DE) 10 2023 115 388.9

(51) Int. Cl. B62D 5/07; B60T 7/12; B60T 13/14; B60T 13/74; B60T 17/22; B62D 5/06; F15B 1/04; F15B 15/18; H02K 7/14

(52) U.S. Cl. CPC B62D 5/075; B60T 13/148; B60T 17/22; B62D 5/064; F15B 1/04; F15B 15/18; H02K 7/14; B60T 7/12; B60T 13/74; B60T 2260/02

(57) ABSTRACT

The present disclosure relates to a hydraulic pump assembly comprising: a variable displacement pump, preferably a load-sensing variable displacement pump, for outputting a volume flow rate of a hydraulic fluid, an electric motor for driving the variable displacement pump, in particular a swashplate or swivel angle pump, via a variable-speed drive shaft, and a control unit which is connected to the variable displacement pump and the electric motor and is configured to provide a predetermined volume flow rate by controlling the variable displacement pump and the electric motor. The hydraulic pump assembly is characterized in that the pump assembly further comprises a temperature sensor connected to the control unit, which senses a winding temperature of the electric motor, wherein as long as the winding temperature is below a threshold, the control unit is configured to provide the predetermined volume flow rate.

### CROSS REFERENCE TO RELATED APPLICATION

The present application claims priority to German Patent Application No. 10 2023 115 388.9 filed on Jun. 13, 2023. The entire contents of the above-listed application are hereby incorporated by reference for all purposes.

### TECHNICAL FIELD

The present disclosure relates to a hydraulic pump assembly, or a mobile working machine with such a hydraulic pump assembly.

### BACKGROUND

Hydraulic drives are used in conventional construction machinery and implements for driving functions, steering functions and various work processes. They are typically powered by a diesel engine via a transfer case that operates one or more hydraulic pumps. These different drives are interconnected, which can have a negative effect on the drive speed of the diesel engine.

By electrifying these machines using individual electric motors, the individual drives become independent in terms of their speed specifications. This makes it possible to decouple the electric traction drives that are normally directly driven by electric motor-driven pump drives. In this way, the delivery volume of the hydraulic system can be set purely by the speed specification of the electric motor. Instead of a hydraulic pump with a variable delivery volume, a so-called variable displacement pump, a simpler and more cost-effective fixed displacement pump can be used.

However, there are situations in which a variable displacement pump driven by an electric motor can be advantageous for the working and steering hydraulics. This applies in particular with regard to energy-efficient operation of the machine in all operating situations.

### SUMMARY

A variable displacement pump is a hydraulic pump that can have a variable delivery volume despite a constant number of revolutions of the drive shaft. The main advantage of this pump is that it can adapt its performance to the respective requirements of the system in which it is used.

The delivery volume of a pump is the amount of liquid that it delivers in a certain time (e.g. per minute). With a variable displacement pump, the delivery volume can be adjusted, i.e. it can be increased or decreased. This is usually done by changing the angle of inclination of the pump vanes or the eccentricity in the pump housing, which in turn influences the available space for the hydraulic medium and therefore the delivery volume. The delivery volume Vg of the variable displacement pump depends on the deflection of the swivel angle of the variable displacement pump. If the swivel angle is small, the delivery volume is also small. If the swivel angle is large, the delivery volume delivered by the variable displacement pump is also large. There is therefore a direct proportional relationship between the flow rate delivered by the variable displacement pump and the deflection of the swivel angle

This ability to adjust the delivery volume enables a variable displacement pump to work very efficiently. It can deliver exactly the amount of hydraulic fluid that is needed at any given time and does not pump excess fluid. This is particularly advantageous in systems where hydraulic power requirements vary, such as in construction machinery where the working speed and load change frequently.

In such a case, the variable displacement pump can, for example, deliver a smaller delivery volume for a first work task and a larger delivery volume for a second work task. This leads to more efficient operation of the machine and can help to save fuel and extend the service life of the pump.

Particularly in the case of electrically powered vehicles or construction and work machines that have a battery as their primary energy source, it is important to minimize power losses and parasitic energy consumption in order to increase the range and service life of the vehicle or even reduce the size of the battery.

The object of the present disclosure is to overcome the above-mentioned disadvantages and create a hydraulic pump assembly which is advantageous in this respect.

This object is achieved by a hydraulic pump assembly as described herein.

The hydraulic pump assembly according to the disclosure comprises a variable displacement pump, preferably a load-sensing variable displacement pump, for outputting a volume flow rate of a hydraulic fluid, an electric motor for driving the variable displacement pump, in particular a swashplate or swivel angle pump, via a variable-speed drive shaft, and a control unit which is connected to the variable displacement pump and the electric motor and is configured to provide a predetermined volume flow rate by controlling the variable displacement pump and the electric motor. The hydraulic pump assembly is characterized in that the pump assembly further comprises a temperature sensor connected to the control unit, which senses a winding temperature of the electric motor, wherein as long as the winding temperature is below a threshold, the control unit is configured to provide the predetermined volume flow rate by means of a maximum delivery rate of the variable displacement pump and the resulting speed of the electric motor, and if the winding temperature reaches or exceeds the threshold, the control unit is configured to provide the specified volumetric flow by means of a reduced delivery rate of the variable displacement pump compared to the maximum delivery rate and the resulting increased speed of the electric motor.

With the open hydraulic circuits of mobile machines, it is possible to utilize the advantages of a load-sensing drive with variable displacement pump. In the case of wheel loaders, for example, this advantage is evident when loading material in that as soon as the movement of the hydraulic cylinders comes to a standstill due to the maximum pressures being reached and can no longer follow the driver's desired specifications, the delivery rate can be reduced by swinging back the variable displacement pump without the need for complex electronic monitoring and control measures.

Whenever possible, however, the variable displacement pump should be operated with a large swivel angle and thus good efficiency, for which an electronic control system consisting of an electronic joystick, electro-hydraulically pilot-controlled valve and speed-controllable variable displacement pump driven by an electric motor is ideal.

The disclosure uses this knowledge and initially operates the variable displacement pump at a maximum swivel angle with a high degree of efficiency so that the variable displacement pump delivers a maximum flow rate. Taking into account the specified volume flow rate, this results in a speed that the electric motor must provide for powering the variable displacement pump. Depending on the activity performed by the pump assembly (high load pressure pLS), the torque to be supplied by the electric motor can be very high, which typically results in an increase in the winding temperature T of the electric motor.

An excessively high winding temperature must be avoided, as otherwise the electric motor may overheat. According to the disclosure, for reasons of efficiency, the variable displacement pump is nevertheless initially operated at the maximum swivel angle for a maximum delivery rate and the swivel angle is only reduced and the speed of the electric motor increased at the same time once a temperature threshold of the electric motor windings has been reached. The flow rate Q remains the same due to increasing the speed n, as the swivel angle of the variable displacement pump, which regulates the flow rate Vg, is reduced. The following relationship applies: Q=Vg×n.

The control unit can be designed in such a way that both the swivel angle and the speed of the electric motor are gradually adjusted until the winding temperature stabilizes. According to the disclosure, it can also be provided that when the temperature falls below a second winding temperature threshold, which is below the aforementioned first winding temperature threshold, the torque of the electric motor is reduced and the swivel angle of the variable displacement pump is increased. Once again, the aim is to work with the maximum flow rate (also known as cubature) of the variable displacement pump whenever the winding temperature permits in order to generate as few losses as possible. The hydraulic-mechanical efficiency η of bent-axis and swashplate drives, as are typically used with variable displacement pumps, is the most favorable in this case.

According to an optional modification of the present disclosure, it may be provided that, in order to provide a predetermined, constant volume flow rate for an attachment in continuous operation, the control unit is configured to determine the delivery rate of the variable displacement pump and the speed of the electric motor as a function of the measured winding temperature, preferably such that
a) starting from a maximum delivery rate of the variable displacement pump, said rate is reduced until the winding temperature stabilizes and no longer exceeds the threshold, or
b) starting from a minimum flow rate of the variable displacement pump, said rate is increased until the winding temperature exceeds the threshold.

For the operation of hydraulic attachments, such as sweeping brushes, snow blowers, salt spreaders or sieve shovels on a wheel loader equipped with the hydraulic pump assembly, the specified volume flow rate Q is required over a longer period of time and is not specified via a manually operated joystick.

The proposed method according to the disclosure is particularly advantageous for air-cooled electric motors, as increasing the speed of the motor not only reduces power losses, but also improves convection cooling. The improvement in cooling typically occurs because the air-cooled motor has a fan wheel mounted on the motor shaft, which generates a greater flow of cooling air when the rotational speed is increased.

According to an advantageous embodiment of the present disclosure, it may be provided that the relationships between the winding temperature, speed tracking of the electric motor and an adjustment of the delivery rate of the variable displacement pump, preferably the energization of a proportional solenoid valve, are stored as characteristic curves in the control unit.

The delivery rate of the variable displacement pump can be adjusted using a proportional solenoid valve, in which a reduction in the power supply also means a reduction in the swivel angle.

The present disclosure also relates to a hydraulic pump assembly, preferably one according to any one of the above-discussed approaches, and comprises a pump, in particular a variable displacement pump or fixed displacement pump, for delivering a volume flow rate of a hydraulic fluid, an electric motor for driving the pump via a variable-speed drive shaft, and a control unit which is connected to the pump and the electric motor and is configured to provide a predetermined volume flow rate by driving the electric motor. The hydraulic pump assembly is characterized in that the control unit is configured to convert a delivery rate specification generated by an operator by means of manual input using the delivery rate of the pump, in particular the delivery rate of a fixed displacement pump or the maximum delivery rate of a variable displacement pump, into a speed specification for the electric motor, preferably to output a specification value from this for energizing an electro-hydraulically pilot-controlled proportional valve. This valve is used to vary the delivery rate of the variable displacement pump.

Furthermore, according to the disclosure, it can be provided that the specification for a speed and/or a delivery rate of the variable displacement pump is specified by a deflection of a joystick or a steering system by an operator and the correlations between the manual actuation request, a speed specification and/or the delivery rate of the variable displacement pump, preferably a current flow of a proportional solenoid valve, are stored in the control unit as formulae and/or as characteristic curves.

Storing characteristic curves in the control unit enables a particularly fast response to the input of an operator with regard to changing a desired volume flow rate. No calculation is initially required, as only the operating point is changed along a characteristic curve depending on the operator input.

During normal operation, the driver specifies a volume flow rate requirement via the deflection of a joystick, either with an electronic joystick or by measuring the pressure in the pilot control circuit with a hydraulic joystick.

In the control unit, the delivery rate requirement Q is determined into a speed requirement n for the drive motor of the variable displacement pump, taking into account the maximum delivery volume Vg,max, and converted accordingly, for example by the frequency inverter.

At the same time, it may be provided that the control unit assigns a valve deflection to the delivery rate request Q, which is implemented by specifying a solenoid valve current I if it is an electrohydraulically pilot-controlled proportional valve for changing the delivery rate of the variable displacement pump.

In the case of a hydraulically pilot-controlled proportional valve, the pilot pressure can be generated by means of a hydraulic joystick.

The correlations between the manual actuation request using a joystick, the speed specification n for the electric motor and the valve opening characteristic (valve current I) for influencing the change in the swivel angle of the variable displacement pump can be stored in the control unit as a formula and/or as characteristic curves.

If the variable displacement pump has sensors to determine the current delivery rate (e.g. by means of a swivel angle sensor), this can be used in the control unit to bring the variable displacement pump even closer to operating at the maximum delivery rate Vg,max.

Alternatively, the current flow rate (also: cubature), [Vg]=cm³, can be determined indirectly by the control unit, e.g. by means of:
the current drive torque as information from a frequency inverter, [M]=Nm,
the measured pump pressure, [p]=bar,

Alternatively, the measured load signal pLS of the working hydraulics plus control differential pressure: p=pLS+Δp, [p]=bar,
a typical hydraulic-mechanical efficiency, [η],
the flow rate Vg=(100*M*η)/(1.59*p).

According to an advantageous modification of the present disclosure, it may be provided that the control unit is further adapted to enter an energy saving mode which becomes active if a hydraulics request is absent for a predetermined time, and the control unit is adapted to monitor the deflection of a joystick for work functions and/or the deflection of a steering during the energy saving mode in order to bring the electric motor back to speed in the event of a delivery rate requirement.

For efficiency reasons, it can be advantageous if an energy-saving mode is entered for a certain time after a hydraulic request has not been received, in which the electric motor of the pump drive is switched off. This happens advantageously whenever no volume flow rate request is received within a predetermined time.

Advantageously, the hydraulic pump assembly can be provided with monitoring of a manual steering actuation, which is implemented by a joystick and/or a steering wheel, and senses a change via an angle or position sensor in order to identify a delivery rate requirement and exit the energy-saving mode.

This ensures that the energy-saving mode is exited and the electric motor restarts when the operator makes a manual steering input.

Preferably, it can be provided that a direction of travel preselection, an accelerator pedal and/or the release of a parking brake is monitored by the control unit in order to identify a delivery rate requirement and exit the energy-saving mode.

According to a further advantageous modification of the present disclosure, it may be provided that the control unit is further designed to automatically activate an electrically actuable parking brake, the parking brake preferably being designed as a negative brake or spring-loaded brake, in order to immobilize the vehicle by the parking brake when entering the energy-saving mode and the brake pressure supply for a hydraulically actuable service brake system is absent.

This ensures that switching off the electric motor in energy-saving mode does not result in the associated deactivation of a parking brake, which requires a certain amount of hydraulic pressure, leading to an unsecured working machine. Finally, a negative brake or a spring-loaded brake can be provided, which brakes the vehicle when it enters energy-saving mode. Accordingly, if the pressure supply for the service brake system fails, an electrically actuated brake is switched on by the control unit, whereby this can be a negative brake that closes in a spring-actuated manner when the actuation pressure is deliberately switched off or does not occur.

It can also be provided that various operating elements are monitored by the control unit during energy-saving mode in order to exit energy-saving mode and switch to working mode when the operating elements are actuated or deflected. In this case, the electric motor can be set to either a minimum speed or a desired working speed via a speed specification.

Thus, when the parking brake is released, when the direction of travel is selected or when the pedal of a mobile working machine equipped with the hydraulic pump assembly is actuated, the control unit can advantageously be designed to initially bring the electric motor to a minimum speed in order to await further input from the operator of the mobile working machine. If, on the other hand, during the energy-saving mode there is an actuation of a joystick or the like specified by the operator, which immediately indicates a desired target speed of the electric motor, the energy-saving mode is exited so that the electric motor immediately assumes the desired speed in order to deliver the specified volume flow rate.

In a further embodiment of the pump assembly, it is provided that the control unit is configured to suppress an energy-saving mode if one or more conditions are met.

This may, for example, be due to certain unfavorable temperature conditions (e.g. cooling circuit fluid, environment, component temperatures) that prevail when the drive is switched off.

It is also conceivable that switching to energy-saving mode is prevented by the driver's request or manual input. The prerequisite can therefore also be a manual input by the operator of the machine.

The energy-saving mode is thus suppressed under certain conditions. Examples of this are cold start conditions, which can be determined on the basis of media temperatures (hydraulic oil, coolants) and ambient temperature, but also increased fluid temperatures or motor winding temperatures, which can be counteracted with increased speed and forced ventilation using a fan wheel on the motor shaft.

This results in a temperature operating range in which the energy-saving mode can be activated. It may be advantageous if the energy-saving mode can be manually suppressed for certain cyclical activities if the constant switching off and on is perceived as annoying, comparable to an automatic start-stop system in a car.

Furthermore, the hydraulic pump assembly may also comprise a pressure sensor for monitoring a load signal from the steering system in order to identify the delivery requirement of a steering system when the engine is operating at minimum speed, so that thereupon the engine speed is increased by the control unit.

According to the disclosure, it may further be provided that the hydraulic pump assembly is further provided with a direct or indirect monitoring of a swivel angle of the variable displacement pump and a speed tracking of the electric motor, which aims to always operate the variable displacement pump with the largest possible delivery rate, ideally with its maximum delivery rate.

It can be advantageously provided in this case that the swivel angle is determined by the control unit directly by means of an angle sensor or indirectly, wherein the indirect determination of the swivel angle is carried out by the control unit by calculating the swivel angle using the pump drive torque, preferably as information from a frequency converter, and the pump pressure sensed by a sensor, taking into account typical efficiencies.

The disclosure also relates to a hydraulic pump assembly, preferably one according to any one of the aspects discussed above, and comprises a load-sensing variable displacement pump for outputting a volume flow rate of a hydraulic fluid, an electric motor for driving the variable displacement pump, in particular a swashplate or swivel angle pump, via a variable-speed drive shaft, a control unit which is connected to the variable displacement pump and the electric motor and is configured to provide a predetermined volume flow rate by controlling the variable displacement pump and the electric motor, and a hydraulically actuated brake system whose supply pressure is above the control differential pressure or standby pressure of the variable displacement pump. stand-by pressure of the variable displacement pump. The hydraulic pump assembly is characterized in that a load pressure requirement is simulated for the variable displacement pump by a valve arrangement, although no load pressure requirement actually exists, so that the simulated load pressure requirement is added to an actual load pressure requirement.

This makes it possible to provide a brake pressure, i.e. the supply pressure of the brake system, although the control differential pressure is actually too low for this.

In principle, flow rate control requires the variable displacement pump to provide a pressure in the order of at least 10 to 20 bar higher than the current load pressure during operation. For the purpose of efficiency, this set value should be as low as possible.

In the case of a common oil supply for several hydraulic circuits, which must also supply a brake system, it may be necessary for the pump to provide a higher pressure in the order of 30 to 40 bar despite the low differential pressure settings in the non-actuated state of a working hydraulic and/or steering system. An artificial load signal pLS in the order of 10 to 20 bar is generated by a valve circuit in the non-actuated state of the working hydraulics and/or steering, so that the pump can provide the required actuation pressure for the service brake system of 30 to 40 bar despite the low differential pressure setting. The actuation pressure required for the brake is made up of the differential pressure setting of the variable displacement pump and the artificially generated load signal.

This measure can reduce losses in manual operation by reducing the differential pressure setting on the pump controller to a minimum.

The disclosure further relates to a hydraulic pump assembly, preferably according to any one of the preceding aspects discussed above and comprising a load-sensing variable displacement pump for outputting a volume flow rate of a hydraulic fluid, an electric motor for driving the variable displacement pump, in particular a swashplate or swivel angle pump, via a variable-speed drive shaft, a control unit which is connected to the variable displacement pump and the electric motor and is configured to provide a predetermined volume flow rate by controlling the variable displacement pump and the electric motor, and a hydraulically actuated brake system whose supply pressure is above the control differential pressure or standby pressure of the variable displacement pump. stand-by pressure of the variable displacement pump. The hydraulic pump assembly is characterized in that the pump assembly also has an accumulator charging valve which charges a hydraulic accumulator for the brake system, preferably with a pressure sensor being provided for the accumulator charging valve in order to control the electric motor as required with the aim of increasing the speed of the pump.

In larger vehicles, the brake system requires a pressure higher than 30 to 40 bar, namely an actuation pressure in the range of 80 to 100 bar for the service brake.

An accumulator solution is suitable for this, for example, wherein the hydraulic accumulator can be charged via an accumulator charging valve. The accumulator charging valve works as a mechanical two-point controller and, when the switch-on pressure is reached, reports the demand to the pump controller via a load signal line (LS signals) as an additional consumer to the working hydraulics and steering, which can cause the variable displacement pump to swivel out.

In connection with the above-mentioned energy-saving mode, a pressure sensor in the load signal line can detect the higher pressure, either that of the steering system or that of the accumulator charging valve.

In this respect, it is also possible to react to the demand of the accumulator charging function after returning from energy-saving mode by detecting the load pressure with a common pressure sensor for the steering and brake system, and to increase the speed of the electric motor accordingly so that the charging of the accumulator up to the cut-off pressure can be completed in a short time.

The disclosure also relates to a pump assembly according to any one of the preceding aspects, wherein the pressure sensor is used to detect the load signal from a steering system and/or an accumulator charging process and the respective signal of higher load is processed by the control unit.

Furthermore, according to an optional modification of the present disclosure, it can be provided that the control unit is configured to determine the flow rate regulation of the variable displacement pump on the basis of a hydraulic load signal of the consumer with the highest load, whereby this determination can take place by means of a mechanical regulator, but can also take place via an electrically proportional adjustment of the delivery volume by means of an electronic controller.

Preferably, the electric motor can be provided with forced ventilation driven by the motor itself by means of at least one fan wheel, so that its ventilation increases with increasing speed.

The fan wheel can be arranged rigidly on the drive shaft for the variable displacement pump or connected to it with a gear wheel.

According to a further modification of the present disclosure, it may be provided that a hydraulic pump assembly according to any one of the aspects presented above further comprises a second pump which, in addition to the variable displacement pump, is also driven by the electric motor. This second pump can, for example, serve to supply a cooling circuit and be driven via the same output shaft of the electric motor as the variable displacement pump. The use of a variable displacement pump in the second pump is also advantageous, as the delivery rate requirement does not necessarily have to be accompanied by an increase in speed, so that the delivery rate of the second pump driven by the electric motor is not necessarily increased (if the first variable displacement pump requires one), which would possibly lead to losses and should be avoided in principle.

The use of the variable displacement pump as a second pump is a possible, non-limiting exemplary embodiment. The disclosure also relates to the use of a fixed displacement pump as a second pump, as shown in the Figures.

The disclosure further relates to a hydraulic drive with a pump assembly according to any one of the preceding aspects discussed for use in a construction and/or work machine, for example a wheel loader, wheel excavator, crawler excavator, tracked loader, crawler dozer and/or articulated dump truck or construction and/or work machine, for example a wheel loader, wheel excavator, crawler excavator, tracked loader, crawler dozer and/or articulated dump truck with a pump assembly according to any one of the aspects discussed above.

### BRIEF DESCRIPTION OF THE FIGURES

Further features, details and advantages of the disclosure will become apparent from the following description of the Figures. Shown are in:

FIG. 1: a schematic diagram to explain the relationship between winding temperature, speed and swivel angle,

FIG. 2a: a schematic diagram to explain the relationship between the speed and drive torque of the pump,

FIG. 2b: a schematic diagram to explain the relationship between the speed and swivel angle of the pump,

FIG. 2c: a schematic diagram explaining the relationship between speed and actuator current for adjusting the swivel angle of the pump,

FIG. 3: a schematic illustration for an artificial load signal in the unactuated state of a working hydraulic system and a steering system for supplying a service brake, and

FIG. 4: A hydraulic diagram with an independent accumulator charging valve for the service brake.

### DETAILED DESCRIPTION

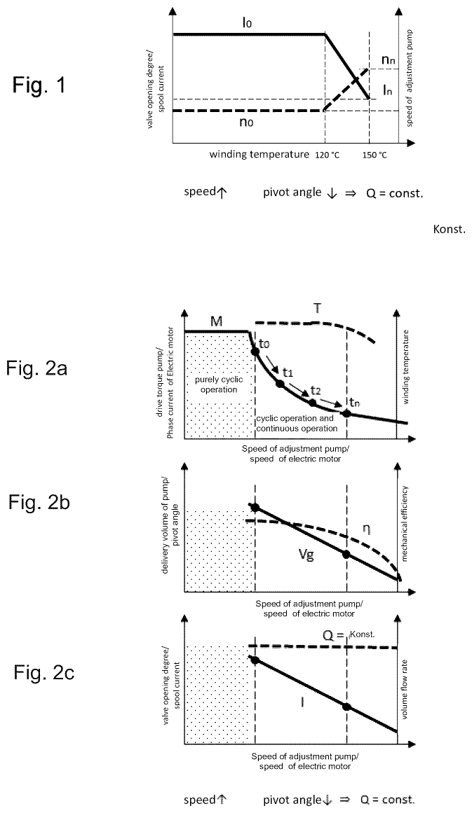

FIG. 1 shows a schematic diagram to explain the relationship between the winding temperature (in degrees Celsius), speed (n) and swivel angle of the variable displacement pump. The spool current or the valve opening is expressed by I and is proportional to the deflection of the swivel angle of the variable displacement pump.

It can be seen that as the winding temperature rises above the specified temperature threshold of 120° C., the current I₀ is reduced. Before lowering, the spool current is responsible for ensuring that the swivel angle of the variable displacement pump is maximally deflected in order to generate the maximum possible delivery volume of the variable displacement pump. As already explained, with a corresponding load on the hydraulic pump assembly, this results in a high torque being generated by the electric motor, which can lead to an increase in the winding temperature. To counteract a further increase in the winding temperature, the spool current is reduced when the temperature threshold of 120° C. is exceeded, which is equivalent to reducing the swivel angle of the variable displacement pump. In order to maintain the required flow rate, it is necessary to increase the speed of the electric motor and thus also the speed of the variable displacement pump, as otherwise the flow rate would decrease as the swivel angle is reduced. The lower efficiency of a reduced swivel angle of the variable displacement pump is therefore accepted in order to prevent a further increase in the winding temperature in the electric motor.

FIG. 2a shows the variation of the drive torque M of the pump, which is generated by the electric motor, compared to the speed of the electric motor or the variable displacement pump. In addition, the winding temperature T is also shown in dashed form.

Normally, the electric motor is operated at a low speed, as the swivel angle of the variable displacement pump is maximized to keep efficiency high. When the pump is applied with a load, this means that a very high torque must be provided by the electric motor. If the winding temperature now exceeds a first temperature threshold, the swivel angle of the variable displacement pump is reduced so that the motor has to run at a higher speed while the flow rate remains the same. If the force acting on the pump assembly remains the same, this results in the torque provided by the electric motor decreasing. These steps are repeated as often as necessary (at the times t₀, t₁, t₂, . . . , tₙ) until the winding temperature no longer exceeds the first temperature threshold. There may be a certain period of time between the individual steps, e.g. 60 seconds or 5 minutes, to wait and see whether the step performed has led to an improvement in the winding temperature.

FIG. 2b shows a diagram which shows the delivery volume Vg of the pump in relation to the speed. In addition, the diagram also shows the hydraulic-mechanical efficiency η of the variable displacement pump in a dashed line.

It can be seen that when the speed of the variable displacement pump or the speed of the electric motor is increased while the flow rate remains the same, the delivery volume of the pump decreases linearly, as the swivel angle is reduced from its maximum deflection. The reduction in the swivel angle is also accompanied by a reduction in the hydraulic-mechanical efficiency n. The efficiency drops significantly the higher the speed of the variable displacement pump. This shows the advantages of a maximum deflection of the swivel angle of the variable displacement pump, as the efficiency of the pump is at its best here.

FIG. 2c shows a diagram in which the speed of the variable displacement pump or the electric motor is shown in relation to the slide valve current for adjusting the swivel angle of the pump. The constant volume flow rate Q is shown in a dashed line.

It can be seen that with an increase in speed at a constant flow rate Q, the spool flow for adjusting the swivel angle of the variable displacement pump decreases, as this is directly proportional to a deflection of the swivel angle. If the spool flow or the swivel angle were not changed by increasing the speed of the variable displacement pump, a higher volumetric flow Q would be obtained, which is not desired in this case.

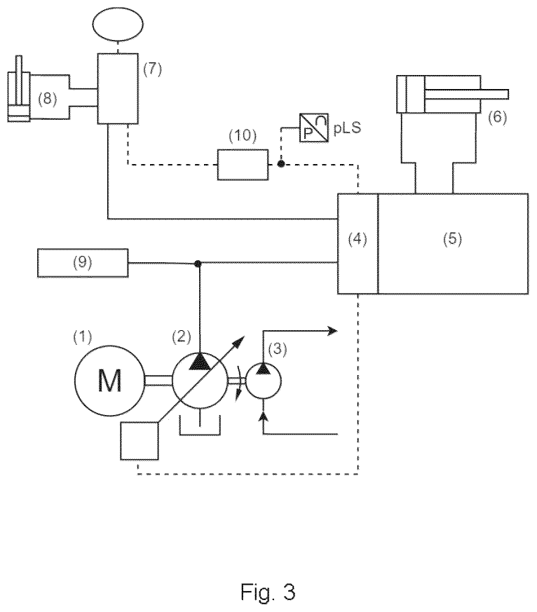

FIG. 3 shows a circuit diagram of a hydraulic pump assembly according to the disclosure.

The electric motor 1 is connected to the variable displacement pump 2 via a drive shaft. Optionally, a further pump 3 can also be provided, which can be a cooling oil pump, for example. Reference character 4 denotes a priority valve that can distribute the flow of liquid in a preferred sequence when several functions are operated simultaneously. This valve 4 ensures that certain hydraulic circuits are given priority if the pump 2 cannot supply enough fluid to operate all circuits simultaneously.

The brake hydraulics 9 are connected upstream of the priority valve 4. The hydraulic steering unit 7 with an exemplary steering cylinder 8 and a control block 5, to which various work functions of a mobile working machine are attached, are connected to the priority valve 4. A working cylinder 6 is also shown here by way of example.

According to the disclosure, it may be provided that the valve circuit 10 generates an artificial load signal pLS, which helps to provide the required actuation pressure for the brake system 9 despite a low differential pressure setting. The valve circuit 10 can, for example, be a preloaded non-return valve, wherein the load signal pLS can be a dynamic load sensing signal generated by the priority valve 4. This measure can reduce the losses during manual operation by reducing the differential pressure setting on the pump controller to a minimum.

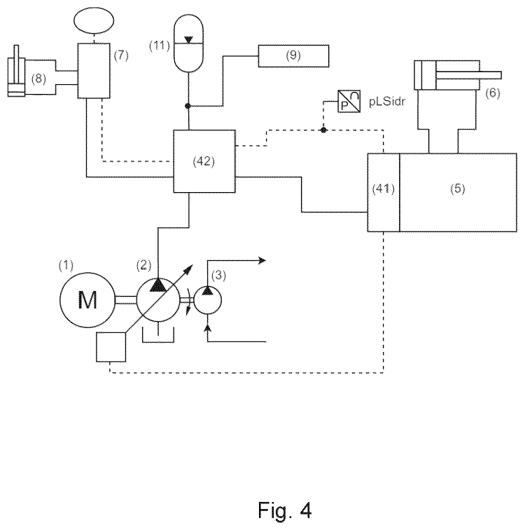

FIG. 4 shows a hydraulic diagram with an independent accumulator charging valve 42 for the service brake.

The wiring differs from that in FIG. 3, and the accumulator charging valve 42 can be seen via which the hydraulic accumulator 11 is charged. When the start-up pressure is reached, the accumulator charging valve 42 signals the demand via a load signal line (LS signals) as an additional consumer for the working hydraulics and the steering system to a pump controller, which causes the variable displacement pump 2 to swivel outward at its swivel angle. The accumulator charging valve 42 could also be regarded as an external priority valve for several consumers.

Accordingly, it is possible to react to the demand of the accumulator charging valve by detecting the load pressure pLSidr. This can be carried out by means of a common pressure sensor for the accumulator charging function, steering and/or braking system. The speed of the electric motor is then increased accordingly so that the charging of the brake accumulator up to the cut-off pressure can be completed in a short time.

### LIST OF REFERENCE CHARACTERS

1 Electric motor
2 Variable displacement pump
3 Cooling oil pump
4 Priority valve
5 Control block “work functions”
6 Working cylinder
7 Hydraulic steering unit
8 Steering cylinder
9 Brake hydraulics
10 Valve technology for increasing the load-sensing signal of the steering system
11 Hydraulic accumulator
41 Control block input without priority spool
42 External priority valve for multiple consumers

1. Hydraulic pump assembly, comprising:
a variable displacement pump,
an electric motor for driving the variable displacement pump via a variable-speed drive shaft, and
a control unit which is connected to the variable displacement pump and the electric motor and is configured to provide a predetermined volume flow rate by controlling the variable displacement pump and the electric motor,
wherein
the pump assembly further comprises a temperature sensor connected to the control unit, which senses a winding temperature of the electric motor, wherein
as long as the winding temperature is below a threshold, the control unit is configured to provide the predetermined volume flow rate by means of a maximum delivery rate of the variable displacement pump and the resulting speed of the electric motor, and
if the winding temperature reaches or exceeds the threshold, the control unit is configured to provide the specified volume flow rate by means of a reduced delivery rate of the variable displacement pump compared to the maximum delivery rate and the resulting increased speed of the electric motor.

2. Hydraulic pump assembly according to the preceding claim 1, wherein, in order to provide a predetermined, constant volume flow rate for an attachment in continuous operation, the control unit is configured to determine the delivery rate of the variable displacement pump and the speed of the electric motor as a function of the measured winding temperature.

3. Hydraulic pump assembly according to claim 2, wherein the correlations of winding temperature, speed tracking of the electric motor and an adjustment of the delivery rate of the variable displacement pump.

4. Hydraulic pump assembly, comprising:
a pump for outputting a volume flow rate of a hydraulic fluid,
an electric motor for driving the pump via a variable-speed drive shaft, and
a control unit which is connected to the pump and the electric motor and is configured to provide a predetermined volume flow rate by controlling the electric motor,
wherein
the control unit is configured to convert a delivery rate specification generated by an operator by means of manual input on the basis of the delivery rate of the pump into a speed specification for the electric motor.

5. Hydraulic pump assembly according to claim 4, wherein the specification for a rotational speed and/or a delivery rate of the variable displacement pump are specified by an operator by a deflection of a joystick or a steering system and the correlations of the manual actuation request, a rotational speed specification and/or the delivery rate of the variable displacement pump are stored in the control unit in the form of a formula and/or as characteristic curves.

6. Hydraulic pump assembly according to claim 4, wherein the control unit is further adapted to enter an energy saving mode which becomes active if a hydraulics request is absent for a predetermined time, and the control unit is adapted to monitor the deflection of a joystick for work functions and/or the deflection of a steering during the energy saving mode in order to bring the electric motor back to speed in the event of a delivery rate requirement.

7. Hydraulic pump assembly according to claim 6, further comprising a monitoring of a manual steering actuation implemented by a joystick and/or a steering wheel and sensing a change via an angle or position sensor in order to identify a delivery rate requirement and to exit the energy-saving mode.

8. Hydraulic pump assembly according to claim 7, wherein a driving direction preselection, an accelerator pedal and/or the release of a parking brake is monitored by the control unit in order to identify a delivery rate requirement and to exit the energy-saving mode.

9. Hydraulic pump assembly according to claim 4, wherein the control unit is further adapted to suppress an energy saving mode when one or more conditions are met.

10. Hydraulic pump assembly according to claim 7, wherein the control unit is further designed to automatically activate an electrically actuable parking brake.

11. Hydraulic pump assembly according to claim 6, further comprising a pressure sensor for monitoring a load signal of the steering system to identify the delivery rate requirement of a steering system when operating the engine at minimum speed, in order to increase the engine speed by means of the control unit.

12. Hydraulic pump assembly according to claim 4, furthermore with direct or indirect monitoring of a swivel angle of the variable displacement pump and speed tracking of the electric motor, which aims to always operate the variable displacement pump with the largest possible delivery rate, in the optimum case with its maximum delivery rate.

13. Hydraulic pump assembly according to claim 12, wherein the detection of the swivel angle by the control unit is determined directly by means of an angle sensor or indirectly, wherein the indirect determination of the swivel angle by the control unit is carried out by calculating the swivel angle on the basis of the pump drive torque and the pump pressure sensed via a sensor, taking into account typical efficiencies.

14. Hydraulic pump assembly, comprising:
a load-sensing variable displacement pump for outputting a volume flow rate of a hydraulic fluid,
an electric motor for driving the variable displacement pump via a variable-speed drive shaft,
a control unit which is connected to the variable displacement pump and the electric motor and is configured to provide a predetermined volume flow rate by controlling the variable displacement pump and the electric motor, and
a hydraulically actuated brake system whose supply pressure is above a control differential pressure or stand-by pressure of the variable displacement pump,
wherein
the pump assembly further comprises an accumulator charging valve which charges a hydraulic accumulator for the brake system, wherein
a pressure sensor is provided for the accumulator charging valve in order to control the electric motor to increase the speed of the pump if necessary.

15. Hydraulic pump assembly according to claim 14, wherein the pressure sensor is used to detect the load signal from a steering system and/or an accumulator charging process and the respectively higher load signal is processed by the control unit.

16. Hydraulic pump assembly according to claim 15, wherein the control unit is configured to determine the flow rate regulation of the variable displacement pump on the basis of a hydraulic load signal of the consumer with the highest load, wherein this determination can take place mechanically, but can also take place by means of an electrically proportional adjustment of the delivery volume by means of electronic control.

17. Hydraulic pump assembly according to claim 15, wherein the electric motor has forced ventilation driven by the motor itself by means of at least one fan wheel, so that its ventilation increases with increasing speed.

18. Hydraulic drive with a pump assembly according to claim 1 for use in a construction and/or work machine.

19. Hydraulic pump assembly of claim 2, wherein the variable displacement pump, is a load-sensing variable displacement pump, wherein the electric motor drive a swashplate or swivel angle of the variable displacement pump via a variable-speed drive shaft,
wherein the control unit is configured to determine the delivery rate of the variable displacement pump and the speed of the electric motor in such a way that
a) starting from a maximum delivery rate of the variable displacement pump, this is reduced until the winding temperature stabilizes and no longer exceeds the threshold, or
b) starting from a minimum delivery rate of the variable displacement pump, this is increased until the winding temperature exceeds the threshold.
